(19) United States
(12) Patent Application Publication
(10) Pub. No.: US 2016/0123736 A1
(43) Pub. Date: May 5, 2016

(54) VIBRATION ELEMENT, ELECTRONIC DEVICE, ELECTRONIC APPARATUS, AND MOVING OBJECT

(71) Applicant: Seiko Epson Corporation, Tokyo (JP)

(72) Inventors: Keiji NAKAGAWA, Minowa (JP); Ryuta NISHIZAWA, Matsumoto (JP)

(21) Appl. No.: 14/923,621

(22) Filed: Oct. 27, 2015

(30) Foreign Application Priority Data
Oct. 30, 2014 (JP) 2014-221155

(51) Int. Cl. G01C 19/5705

(52) U.S. Cl. CPC G01C 19/5705

(57) ABSTRACT

An vibration element includes a drive vibration section and a detection vibration section, and the detection vibration section has a detection mode 1 and a detection mode 2 as an vibration mode for detection in which the detection vibration section resonates with Coriolis force produced in the drive vibration section and vibrates. A resonance frequency (vibration frequency) of the drive vibration section is higher than a resonance frequency (vibration frequency) in the detection mode 1 and a resonance frequency (vibration frequency) in the detection mode 2, or the vibration frequency of the drive vibration section is lower than the resonance frequency (vibration frequency) in the detection mode 1 and the resonance frequency (vibration frequency) in the detection mode 2.

### BACKGROUND

1. Technical Field

The present invention relates to an vibration element, an electronic device, an electronic apparatus, and a moving object.

2. Related Art

A gyro sensor using a gyro element as an example of an vibration element is widely used, for example, in a compact information apparatus, such as a mobile computer and an IC card, a mobile communication apparatus, such as a portable phone, and vehicle body control and vehicle position detection, and a vibration control/correction function (what is called hand-shake correction) for a digital camera, a digital video camcorder, and other imaging apparatus. For example, the gyro sensor, which uses a gyro element (gyro vibration piece), detects angular velocity in the form of an electric signal produced in part of the gyro vibration piece by vibration of an object, such as swinging or rotating motion thereof, and calculates the angle of rotation to determine the displacement of the object.

In recent years, as the size of an electronic apparatus is reduced, a gyro sensor using a gyro element as an example of an vibration element is required to achieve size reduction. As the size of a gyro sensor is reduced, the gyro element is naturally required to achieve size reduction. In a gyro element, when the size thereof is reduced, the mass of a drive vibration section is reduced, resulting in a decrease in the magnitude of Coriolis force expressed by F=2mvΩ (m: mass, v: vibration velocity, and Ω: angular velocity), and an increase in rigidity of the drive vibration section accompanied by a decrease in displacement thereof produced by the Coriolis force. As a result, detection sensitivity of a detection vibration section decreases, possibly resulting in a decrease in detection accuracy.

In contrast, for example, JP-A-2012-98091 discloses an vibration element in which a spectrum of detection sensitivity of a detection vibration section has a first peak that peaks at a first resonance frequency in a first detection vibration mode in which a drive vibration section and the detection vibration section vibrate in opposite phases and a second peak that peaks at a second resonance frequency in a second detection vibration mode in which the drive vibration section and the detection vibration section vibrate in phase. The detection sensitivity is improved by providing the spectrum of the detection sensitivity of the vibration element with a third resonance frequency in a drive mode of the drive vibration section between the first resonance frequency and the second resonance frequency.

However, in the vibration element in JP-A-2012-98091 described above, in which the third resonance frequency in the drive mode of the drive vibration section is placed between the first resonance frequency and the second resonance frequency, the region between the first resonance frequency and the second resonance frequency is a region where the detection sensitivity greatly changes in detuning adjustment in which the resonance frequencies of the drive vibration section and the detection vibration section are adjusted for suppression of undesired vibration leakage, such as leakage output. Therefore, to suppress the undesired vibration leakage, such as leakage output, trimming or any other operation is performed in the detuning adjustment, in which the resonance frequencies of the drive vibration section and the detection vibration section are adjusted, possibly undesirably resulting in a large change in the detection sensitivity and hence variation in the detection sensitivity.

### SUMMARY

An advantage of some aspects of the invention can be implemented as the following forms or application examples.

### APPLICATION EXAMPLE 1

An vibration element according to this application example includes a drive vibration section and a detection vibration section that resonates with Coriolis force produced in the drive vibration section and vibrates. The detection vibration section has a detection mode 1 and a detection mode 2 as an vibration mode for detection, and an vibration frequency of the drive vibration section is higher than an vibration frequency in the detection mode 1 and an vibration frequency in the detection mode 2, or the vibration frequency of the drive vibration section is lower than the vibration frequency in the detection mode 1 and the vibration frequency in the detection mode 2.

According to this application example, in which the drive vibration section has an vibration frequency in an area where a spectrum representing correlation between the vibration frequencies (resonance frequencies) and detection sensitivity (element sensitivity) has a gentle inclination, performing trimming or any other operation in detuning adjustment does not cause a decrease or variation in the detection sensitivity. Further, although the amount of trimming in the detuning adjustment varies also in accordance with variation in the shape of the vibration element at the time of manufacturing, performing the detuning adjustment (trimming) in the area where the change in the sensitivity is small prevents a decrease or variation in detection sensitivity that occurs due to the fact that the detuning adjustment depends on the shape variation at the time of manufacturing.

### APPLICATION EXAMPLE 2

In the vibration element according to the application example, it is preferable that a degree of detuning between the vibration frequency of the drive vibration section and the vibration frequency of the detection vibration section is greater than or equal to −8% but smaller than or equal to −0.5% when the vibration frequency of the drive vibration section is higher than the vibration frequency in the detection mode 1 and the vibration frequency in the detection mode 2, whereas greater than or equal to 0.5% but smaller than or equal to 8% when the vibration frequency of the drive vibration section is lower than the vibration frequency in the detection mode 1 and the vibration frequency in the detection mode 2.

According to this application example, in which a drive vibration mode (resonance frequency of drive vibration) is present in an area where a spectrum representing correlation between the degree of detuning in the detuning adjustment and the detection sensitivity (element sensitivity) changes by a small amount, performing trimming or any other operation in the detuning adjustment does not cause a decrease or variation in the detection sensitivity.

### APPLICATION EXAMPLE 3, APPLICATION EXAMPLE 4

It is preferable that the vibration element according to the application example further includes a base section, and the drive vibration section and the detection vibration section extend from the base section, and at least one of the drive vibration section and the detection vibration section has one end facing the base section and a wide section provided at another end of the vibration section that faces away from the one end.

According to these application examples, since predetermined drive vibration and detection vibration are provided while suppressing in the lengths of the drive vibration arm and the detection vibration arm each or both of which is provided with the wide section, and a wide adjustment range in the detuning adjustment ca be secured, an vibration element that is more compact and characterized by higher sensitivity can be provided.

### APPLICATION EXAMPLE 5, APPLICATION EXAMPLE 6

In the vibration element according to the application example, it is preferable that the wide section is a mass adjustment section.

According to these application examples, performing mass adjustment on the wide section, for example, trimming the wide section allows efficient detuning adjustment.

### APPLICATION EXAMPLE 7, APPLICATION EXAMPLE 8, APPLICATION EXAMPLE 9, APPLICATION EXAMPLE 10

An electronic device according to each of these application examples includes the vibration element according to any one of the application examples and at least a circuit section that drives the vibration element and a package that accommodates at least one of the vibration element and the circuit section.

According to these application examples, an electronic device including the vibration element having the advantageous effects described in any one of the above application examples. In addition, the electronic device of a package type having the configuration described above is advantageous in reduction in size and thickness and capable of increasing impact resistance.

### APPLICATION EXAMPLE 11, APPLICATION EXAMPLE 12

An electronic apparatus according to each of these application examples includes the vibration element described in any one of the above application examples.

According to these application examples, in which an vibration element having a stable detection characteristic is provided, an electronic apparatus having stable performance can be provided.

### APPLICATION EXAMPLE 13, APPLICATION EXAMPLE 14

A moving object according to each of these application examples includes the vibration element according to any one of the application examples.

According to these application example, in which an vibration element having a stable detection characteristic is provided, a moving object having stable performance can be provided.

### BRIEF DESCRIPTION OF THE DRAWINGS

The invention will be described with reference to the accompanying drawings, wherein like numbers reference like elements.

FIGS. 1A and 1B schematically show an H-shaped gyro element as an example of an vibration element according to a first embodiment of the invention. FIG. 1A is a perspective view, and FIG. 1B is a plan view.

FIGS. 2A and 2B describe the electrode configuration of the H-shaped gyro element according to the first embodiment. FIG. 2A is a cross-sectional view taken along the line C-C in FIG. 1B, and FIG. 2B is a cross-sectional view taken along the line D-D in FIG. 1B.

FIG. 3 is a graph showing correlation of resonance frequencies in a detection mode 1, a detection mode 2, and a drive mode with element sensitivity.

FIGS. 4A and 4B show examples of correlation of the resonance frequencies in the detection mode 1, the detection mode 2, and the drive mode with the element sensitivity. FIG. 4A shows a case 1, and FIG. 4B shows a case 2.

FIGS. 5A and 5B show examples of correlation of the degree of detuning with the element sensitivity. FIG. 5A shows correlation of the degree of detuning with reference to the detection mode 2, and FIG. 5B is a graph showing the correlation of the degree of detuning with element sensitivity variation.

FIG. 6 is a plan view schematically showing an electrostatically driven gyro element as an example of an vibration element according to a second embodiment of the invention.

FIGS. 7A and 7B schematically show the electrostatically driven gyro element according to the second embodiment. FIG. 7A is a cross-sectional view taken along the line E-E in FIG. 6, and FIG. 7B is a cross-sectional view taken along the line F-F in FIG. 6.

FIG. 8 is a front cross-sectional view showing a schematic configuration of a gyro sensor as an example of an electronic device according to an embodiment of the invention.

FIGS. 9A to 9C are perspective views showing examples of an electronic apparatus including an vibration element.

FIG. 10 is a perspective view showing an automobile as a moving object including an vibration element.

### DESCRIPTION OF EXEMPLARY EMBODIMENTS

### First Embodiment

### Gyro Element-1

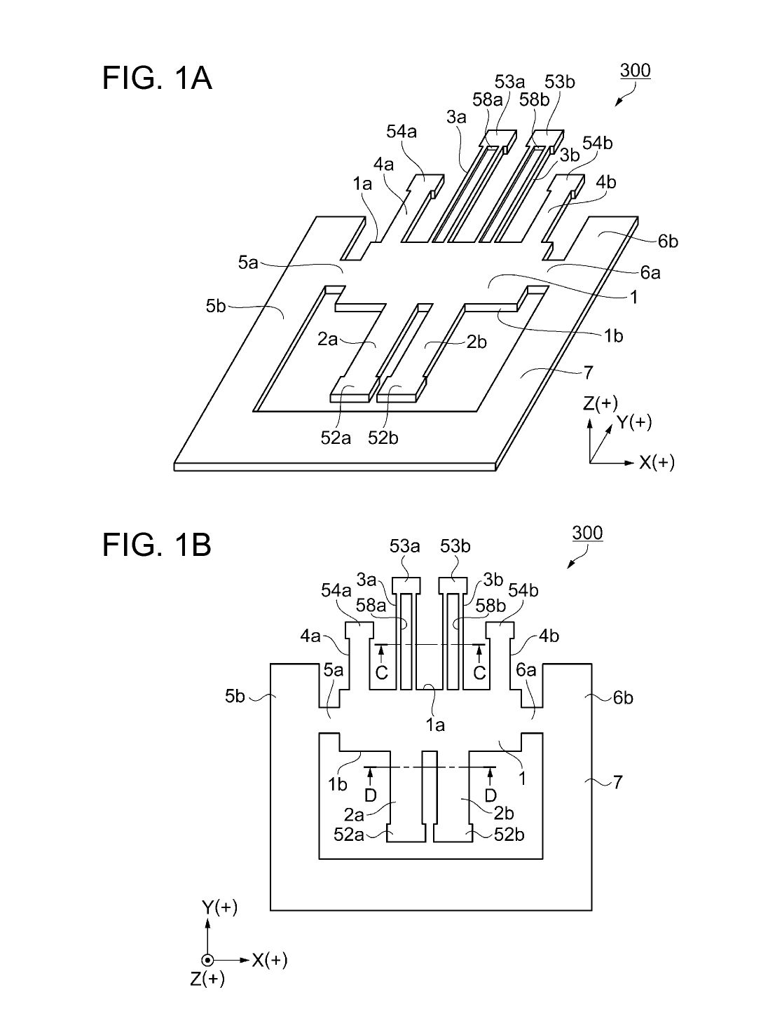

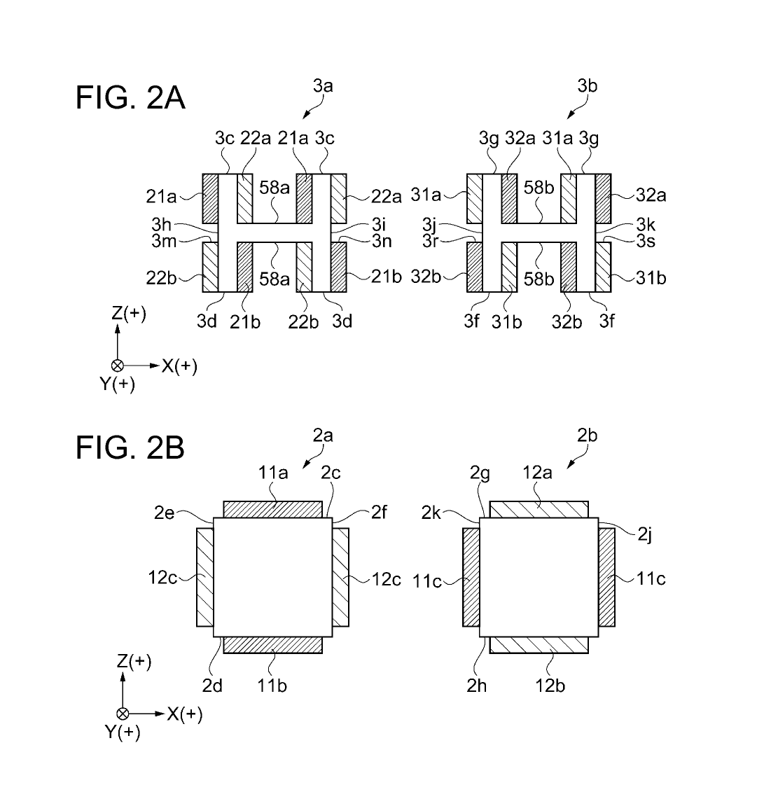

A gyro element as an vibration element according to a first embodiment of the invention will first be described with reference to FIGS. 1A and 1B and FIGS. 2A and 2B. FIGS. 1A and 1B show an embodiment of the gyro element. FIG. 1A is a schematically shown perspective view, and FIG. 1B is a schematically shown plan view. FIGS. 2A and 2B describe the electrode configuration of the gyro element. FIG. 2A is a cross-sectional view taken along the line C-C in FIG. 1B, and FIG. 2B is a cross-sectional view taken along the line D-D in FIG. 1B.

A gyro element 300 according to the first embodiment includes a base section 1, which is formed by processing a base material (material that forms key portion) into an integrated portion, drive vibration arms 2a and 2b as a drive vibration section and detection vibration arms 3a and 3b as a detection vibration section, and adjustment vibration arms 4a and 4b, as shown in FIG. 1A. Further, a first connection section 5a, which extends from the base section 1, a first support section 5b, which is connected to the first connection section 5a, a second connection section 6a, which extends from the base section 1 in the direction opposite the first connection section 5a, and a second support section 6b, which is connected to the second connection section 6a are provided. Moreover, the first support section 5b and the second support section 6b are integrally connected to each other on the side where the drive vibration arms 2A and 2B are present to form a fixing frame section 7. The gyro element 300 is fixed to a substrate that is not shown, such as a package, in a predetermined position on the fixing frame section 7.

The gyro element 300 according to the present embodiment will be described with reference to a case where the base material is quartz, which is a piezoelectric material. Quartz has an X axis called an electrical axis, a Y axis called a mechanical axis, and a Z axis called an optical axis. In the present embodiment, the description will be made of a case where the base material is what is called a quartz Z plate produced by cutting a quartz block along a plane defined by the X axis and the Y axis perpendicular to each other among the quartz crystal axes and processing the cut block into a flat plate having a predetermined thickness t in the Z-axis direction perpendicular to the plane. The predetermined thickness t in the description is appropriately set in consideration of an vibration frequency (resonance frequency), an exterior size, processability, and other factors. The flat plate that forms the gyro element 300 can tolerate an error in the angle at which the quartz block is cut to some extent for each of the X, Y, and Z axes. For example, a flat plate cut along a plane rotated around the X axis by 0 to 2 degrees can be used. The same holds true for the Y and Z axes.

The gyro element 300 includes the base section 1, which is positioned in a central portion of the gyro element 300 and has a roughly rectangular shape, the pair of drive vibration arms 2a and 2b (drive vibration section), which extend along the Y axis in parallel to each other from one of Y-axis-direction ends 1a and 1b of the base section 1 or one end 1b (−Y-axis-direction end in FIGS. 1A and 1B), and the pair of detection vibration arms 3a and 3b (detection vibration section), which extend along the Y axis in parallel to each other from the other end 1a (+Y-axis-direction end in FIGS. 1A and 1B) of the base section 1. The pair of drive vibration arms 2a and 2b and the pair of detection vibration arms 3a and 3b thus extend from the opposite ends 1a and 1b of the base section 1, respectively, in the same axial direction. Based on the shape described above, the gyro element 300 according to the present embodiment is called an H-shaped gyro element in some cases. In the H-shaped gyro element 300, in which the drive vibration arms 2a and 2b and the detection vibration arms 3a and 3b extend from the opposite ends 1a and 1b of the base section 1 in the same axial direction, a drive system and a detection system are separate from each other. The gyro element 300, in which the drive system and the detection system are separate from each other, is characterized by reduced inter-electrode or inter-wiring electrostatic coupling between the drive system and the detection system and hence stable detection sensitivity. In the present embodiment, in which an H-shaped vibration piece is presented by way of example, two drive vibration arms and two detection vibration arms are provided, each of the two types of vibration arm may be formed of one vibration armor three or more vibration arms. Further, drive electrodes and detection electrodes, which will be described later, may be formed on a single vibration arm.

When angular velocity ω around the Y axis acts on the H-shaped gyro element 300 with the pair of drive vibration arms 2a and 2b as the drive vibration section vibrating in an in-plane direction (+X-axis direction and −X-axis direction) at a predetermined resonance frequency, Coriolis force is produced in the drive vibration arms 2a and 2b, and the drive vibration arms 2a and 2b perform bending vibration in an out-of-plane direction (+Z-axis direction and −Z-axis direction) perpendicular to the in-plane direction but in opposite directions. The detection vibration arms 3a and 3b as the detection vibration section resonate with the bending vibration of the drive vibration arms 2a and 2b in the out-of-plane direction and perform bending vibration in the out-of-plane direction similarly. At this point, a piezoelectric effect allows generation of charge in detection electrodes provided on the detection vibration arms 3a and 3b. The gyro element 300 can detect the charge to detect the angular velocity ω acting on the gyro element 300.

The pair of drive vibration arms 2a and 2b as vibration arms extending from the base section 1 include front surfaces 2c and 2g, rear surfaces 2d and 2h, which are provided on the side opposite the front surfaces 2c and 2g, and side surfaces 2e, 2f, 2k and 2j, which connect the front surfaces 2c and 2g to the rear surfaces 2d and 2h, as shown in FIG. 2B. Further, each of the drive vibration arms 2a and 2b has one end facing the base section 1 and the other end facing way from the one end, and weight sections 52a and 52b as a wide section, which are wider than the drive vibration arms 2a and 2b (have greater dimension in X-axis direction) and each have a roughly rectangular shape, are provided at the other-end-side front end portions of the drive vibration arms 2a and 2b (see FIGS. 1A and 1B). Providing the drive vibration arms 2a and 2b with the weight sections 52a and 52b allows predetermined drive vibration to be produced with no increase in the length (dimension in Y-axis direction) of the drive vibration arms 2a and 2b, whereby the size of the gyro element can be reduced. The drive vibration arms 2a and 2b are provided with electrodes for driving the drive vibration arms 2a and 2b, and the configuration of the electrodes will be described later.

The detection vibration arms 3a and 3b as the pair of vibration arms extending from the base section 1 include front surfaces 3c and 3g, rear surfaces 3d and 3f, which are provided on the side opposite the front surfaces 3c and 3g, and side surfaces 3h, 3i, 3j and 3k, which connect the front surfaces 3c and 3g to the rear surfaces 3d and 3f. Further, each of the detection vibration arms 3a and 3b has one end facing the base section 1 and the other end facing way from the one end, and weight sections 53a and 53b as a wide section, which are wider than the detection vibration arms 3a and 3b (have greater dimension in X-axis direction) and each have a roughly rectangular shape, are provided at the other-end-side front end portions of the detection vibration arms 3a and 3b (see FIGS. 1A and 1B). Providing the detection vibration arms 3a and 3b with the weight sections 53a and 53b also allows predetermined detection vibration to be produced with no increase in the length (dimension in Y-axis direction) of the detection vibration arms 3a and 3b, whereby the size of the gyro element can be reduced. The pair of detection vibration arms 3a and 3b are further provided with recesses 58a and 58b. The recesses 58a and 58b in the present embodiment are formed by engraving the detection vibration arms 3a and 3b through both the front surfaces 3c and 3g and the rear surfaces 3d and 3f, as shown in FIG. 2A. The recesses 58a and 58b may instead be formed by engraving the detection vibration arms 3a and 3b engraved through either the front surfaces 3c and 3g or the rear surfaces 3d and 3f.

The gyro element 300 is further provided with the pair of adjustment vibration arms 4a and 4b so configured that the adjustment vibration arms 4a and 4b extend from the base section 1 in the direction that intersects the quartz crystal X axis (electrical axis) in parallel to the detection vibration arms 3a and 3b and sandwich the detection vibration arms 3a and 3b inside the adjustment vibration arms 4a and 4b, as shown in FIGS. 1A and 1B. That is, the adjustment vibration arms 4a and 4b are so provided that they extend along the Y axis in the +Y-axis direction in parallel to each other and so positioned that they sandwich the detection vibration arms 3a and 3b but are separate therefrom by a predetermined distance. The adjustment vibration arms 4a and 4b are called tuning arms in some cases. Providing the thus configured adjustment vibration arms 4a and 4b allows adjustment of leakage output. In other words, charge produced when drive vibration leaks (propagates) or produced by what is called vibration leakage can be canceled by adjusting the charge produced in the adjustment vibration arms 4a and 4b, whereby vibration leakage output can be suppressed and hence vibration characteristics of the gyro element 300 can be stabilized.

The adjustment vibration arms 4a and 4b are so formed that the total length thereof is shorter than those of the drive vibration arms 2a and 2b and the detection vibration arms 3a and 3b. Vibration of the thus configured adjustment vibration arms 4a and 4b for adjustment of leakage output does not obstruct primary vibration of the gyro element 300 produced by the drive vibration arms 2a and 2b and the detection vibration arms 3a and 3b, advantageously resulting in stable vibration characteristics of the gyro element 300 and reduction in the size of the gyro element 300.

Further, each of the adjustment vibration arms 4a and 4b has one end facing the base section 1 and the other end facing way from the one end, and weight sections 54a and 54b as a wide section, which are wider than the adjustment vibration arms 4a and 4b (have greater dimension in X-axis direction) and each have a roughly rectangular shape, are provided at the other-end-side front end portions of the adjustment vibration arms 4a and 4b. Providing the weight sections 54a and 54b at the front end portions of the adjustment vibration arms 4a and 4b allows reduction in the length of the adjustment vibration arms 4a and 4b.

The center of the base section 1 can be the center of gravity of the gyro element 300. It is assumed that the X axis, the Y axis, and the Z axis are perpendicular to each other and pass through the center of gravity. The exterior shape of the gyro element 300 can be symmetric with respect to an imaginary center line extending in the Y axis direction and passing through the center of gravity. The exterior shape is preferable because the gyro element 300 has a balanced exterior shape and stable characteristics and hence has improved detection sensitivity. The exterior shape of the gyro element 300 described above can be formed in etching (wet or dry etching) using a photolithography technology. A plurality of gyro elements 300 can be formed in a single quartz wafer.

An embodiment of electrode arrangement of the gyro element 300 will next be described with reference to FIGS. 2A and 2B. FIG. 2A shows the cross section of the detection vibration arms 3a and 3b taken along the line C-C in FIG. 1B, and FIG. 2B shows the cross section of the drive vibration arms 2a and 2b taken along the line D-D in FIG. 1B.

A description will first be made of detection electrodes that are formed on the detection vibration arms 3a and 3b and detect distortion produced in the quartz that is the base material when the detection vibration arms 3a and 3b vibrate. As shown in FIG. 2A, the detection vibration arms 3a and 3b are provided with the recesses 58a and 58b, as described above. The recesses 58a and 58b in the present embodiment are provided on both sides through the front surfaces 3c, 3g and the rear surfaces 3d, 3f.

The detection vibration arm 3a has a first detection electrode 21a and a second detection electrode 22b provided on the side surface 3h, and the first detection electrode 21a, which is shifted toward the front surface 3c, and the second detection electrode 22b, which is shifted toward the rear surface 3d, are divided by an electrode division section 3m located roughly at the center of the detection vibration arm 3a in the thickness direction thereof (Z-axis direction) and provided along the direction in which the detection vibration arm 3a extends (Y-axis direction). Further, a second detection electrode 22a is provided on the inner side surface of the recess 58a facing the first detection electrode 21a, and a first detection electrode 21b is provided on the inner side surface of the recess 58a facing the second detection electrode 22b. The detection vibration arm 3a further has another second detection electrode 22a and another first detection electrode 21b provided on the side surface 3i facing away from the side surface 3h, and the second detection electrode 22a, which is shifted toward the front surface 3c, and the first detection electrode 21b, which is shifted toward the rear surface 3d, are divided by an electrode division section 3n located roughly at the center of the detection vibration arm 3a in the thickness direction thereof and provided along the direction in which the detection vibration arm 3a extends. Further, another first detection electrode 21a is provided on the inner side surface of the recess 58a facing the second detection electrode 22a, and another second detection electrode 22b is provided on the inner side surface of the recess 58a facing the first detection electrode 21b.

The first detection electrodes 21a and the first detection electrodes 21b are electrically connected to each other, although not shown, for example, via front end portions of the detection vibration arm 3a. The second detection electrodes 22a and the second detection electrodes 22b are electrically connected to each other, although not shown, for example, via front end portions of the detection vibration arm 3a. Each of the first detection electrodes 21a, 21b and the second detection electrodes 22a, 22b extends to a position in the vicinity of a front end of the detection vibration arm 3a. Each of the first detection electrodes 21a, 21b and the second detection electrodes 22a, 22b is electrically connected to an external connection pad that is not shown via a wiring line that is not shown. The first detection electrodes 21a, 21b and the second detection electrodes 22a, 22b are also electrically connected to adjustment electrodes that are not shown but are formed on the adjustment vibration arm 4a (see FIGS. 1A and 1B).

Similarly, the detection vibration arm 3b has a second detection electrode 31a and a first detection electrode 32b provided on the side surface 3j, and the second detection electrode 31a, which is shifted toward the front surface 3g, and the first detection electrode 32b, which is shifted toward the rear surface 3f, are divided by an electrode division section 3r located roughly at the center of the detection vibration arm 3b in the thickness direction thereof (Z-axis direction) and provided along the direction in which the detection vibration arm 3b extends (Y-axis direction). Further, a first detection electrode 32a is provided on the inner side surface of the recess 58b facing the second detection electrode 31a, and a second detection electrode 31b is provided on the inner side surface of the recess 58b facing the first detection electrode 32b. The detection vibration arm 3b further has another first detection electrode 32a and another second detection electrode 31b provided on the side surface 3k facing away from the side surface 3j, and the first detection electrode 32a, which is shifted toward the front surface 3g, and the second detection electrode 31b, which is shifted toward the rear surface 3f, are divided by an electrode division section 3s located roughly at the center of the detection vibration arm 3b in the thickness direction thereof and provided along the direction in which the detection vibration arm 3b extends. Further, another second detection electrode 31a is provided on the inner side surface of the recess 58b facing the first detection electrode 32a, and another first detection electrode 32b is provided on the inner side surface of the recess 58b facing the second detection electrode 31b.

The second detection electrodes 31a and the second detection electrodes 31b are electrically connected to each other, although not shown, for example, via front end portions of the detection vibration arm 3b. The first detection electrodes 32a and the first detection electrodes 32b are electrically connected to each other, although not shown, for example, via front end portions of the detection vibration arm 3b. Each of the second detection electrodes 31a, 31b and the first detection electrodes 32a, 32b extends to a position in the vicinity of a front end of the detection vibration arm 3b. Each of the second detection electrodes 31a, 31b and the first detection electrodes 32a, 32b is electrically connected to an external connection pad that is not shown via a wiring line that is not shown. The second detection electrodes 31a, 31b and the first detection electrodes 32a, 32b are also electrically connected to adjustment electrodes that are not shown but are formed on the adjustment vibration arm 4b (see FIGS. 1A and 1B).

In the detection vibration arm 3a, the first detection electrodes 21a and the first detection electrodes 21b are so connected to each other that they have the same potential, and the second detection electrodes 22a and the second detection electrodes 22b are so connected to each other that they have the same potential. In this configuration, distortion produced by the vibration of the detection vibration arm 3a is detected through detection of an inter-electrode potential difference between the first detection electrodes 21a, 21b and the second detection electrodes 22a, 22b. Similarly, in the detection vibration arm 3b, the first detection electrodes 32a and the first detection electrodes 32b are so connected to each other that they have the same potential, and the second detection electrodes 31a and the second detection electrodes 31b are so connected to each other that they have the same potential. In this configuration, distortion produced by the vibration of the detection vibration arm 3b is detected through detection of an inter-electrode potential difference between the first detection electrodes 32a, 32b and the second detection electrodes 31a, 31b.

A description will next be made of drive electrodes 11a, 11b, 11c, 12a, 12b, and 12c, which are provided on the drive vibration arms 2a and 2b, for driving the drive vibration arms 2a and 2b. As shown in FIG. 2B, the drive electrode 11a is formed on the front surface (one principal surface) 2c of the drive vibration arm 2a, and the drive electrode 11b is formed on the rear surface (the other principal surface) 2d of the drive vibration arm 2a except on the weight section 52a (see FIGS. 1A and 1B). The drive electrodes 12c are formed on one side surface 2e and the other side surface 2f of the drive vibration arm 2a except on the weight section 52a of the drive vibration arm 2a (see FIGS. 1A and 1B). Similarly, the drive electrode 12a is formed on the front surface (one principal surface) 2g of the drive vibration arm 2b, and the drive electrode 12b is formed on the rear surface (the other principal surface) 2h of the drive vibration arm 2b except on the weight section 52b (see FIGS. 1A and 1B). The drive electrodes 11c are formed on one side surface 2j and the other side surface 2k of the drive vibration arm 2b except on the weight section 52b of the drive vibration arm 2b (see FIGS. 1A and 1B).

The drive electrodes 11a, 11b, 11c, 12a, 12b, and 12c formed on the drive vibration arms 2a and 2b are so arranged that drive electrodes disposed on opposite sides of the drive vibration arm 2a or 2b have the same potential. Although not shown, when a potential difference is alternately produced between the drive electrodes 11a, 11b, 11c and the drive electrodes 12a, 12b, 12c via a connection pad formed on a first fixing section to which the drive electrodes 11a, 11b, and 11c are connected and a connection pad formed on a second fixing section to which the drive electrodes 12a, 12b, and 12c are connected, the drive vibration arms 2a and 2b are so excited that they undergo what is called tuning-fork vibration.

A description will next be made of electrodes provided on the adjustment vibration arms 4a and 4b. Although not shown, adjustment electrodes having the same potential are formed on the front and rear surfaces of the adjustment vibration arm 4a. Further, other adjustment electrodes having the same potential are formed on the opposite side surfaces of the adjustment vibration arm 4a. Similarly, adjustment electrodes having the same potential are formed on the front and rear surfaces of the adjustment vibration arm 4b. Further, other adjustment electrodes having the same potential are formed on the opposite side surfaces of the adjustment vibration arm 4b.

The drive electrodes 11a, 11b, 11c, 12a, 12b, and 12c, the first detection electrodes 21a, 21b, 32a, and 32b, the second electrodes 22a, 22b, 31a, and 31b, and the adjustment electrodes are not necessarily configured in a specific manner and may be configured in any way in which conductivity is provided and thin film formation is allowed. As a specific configuration, the electrodes can be made of gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), zirconium (Zr), or any other metal material, or indium tin oxide (ITO) or any other conductive material.

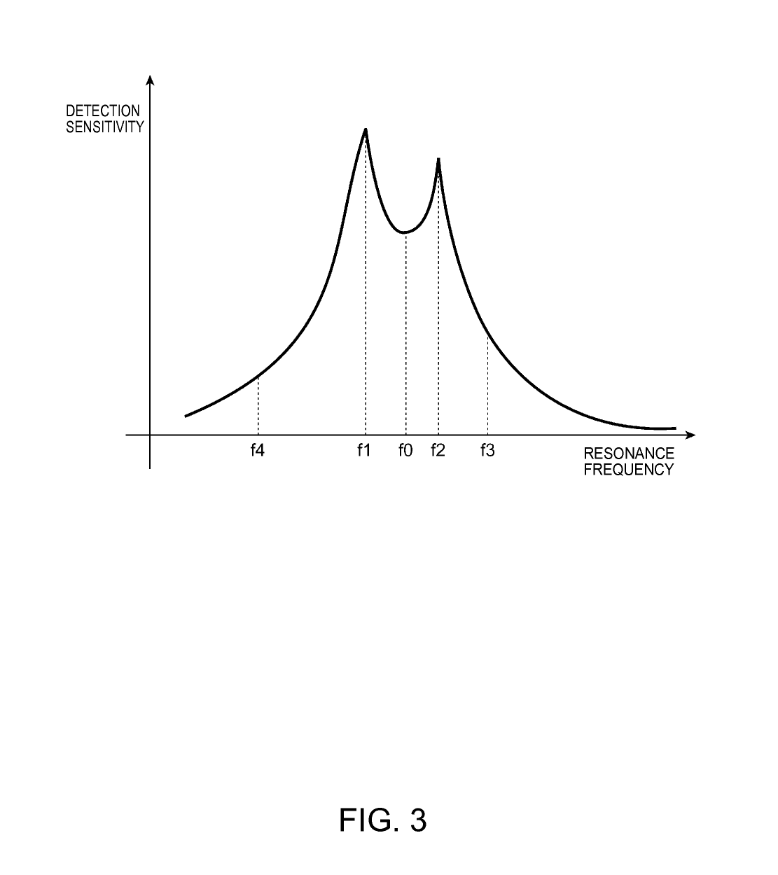

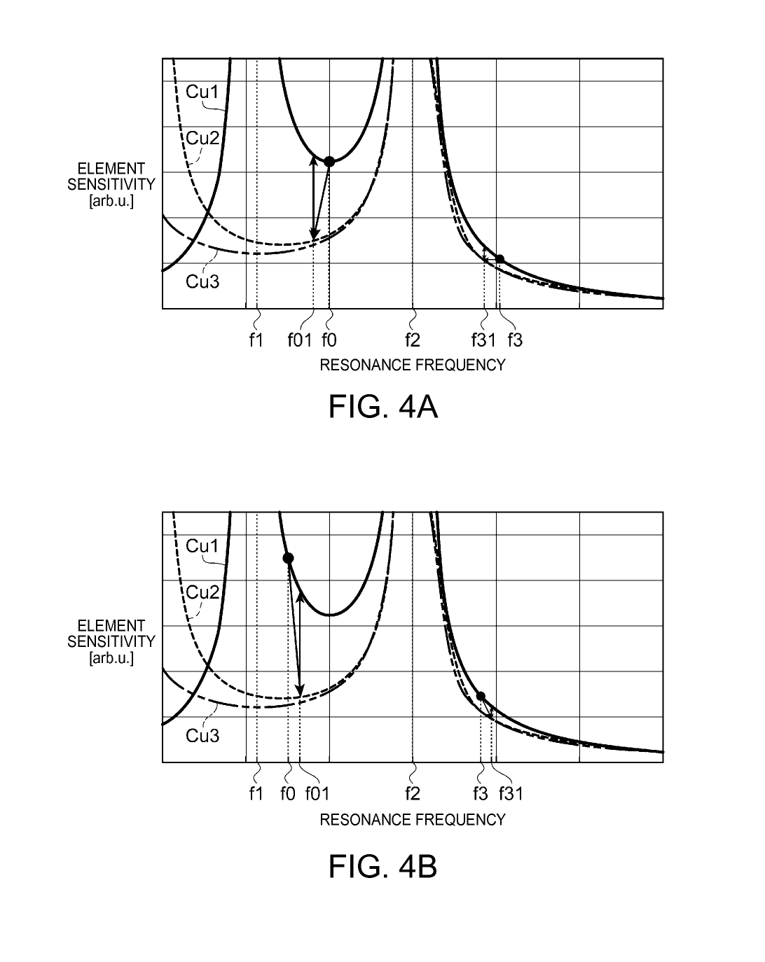

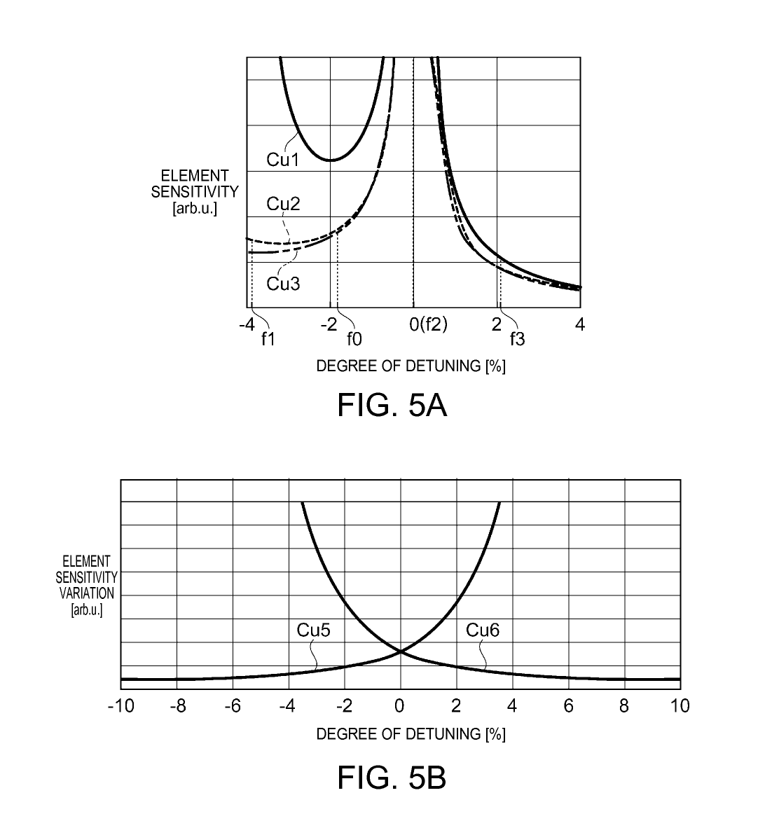

A description will next be made of vibration modes of the gyro element 300 with reference to FIG. 3, FIGS. 4A and 4B, and FIGS. 5A and 5B. FIG. 3 is a graph showing a spectrum representing the correlation of the resonance frequencies in a detection mode 1, a detection mode 2, and a drive mode as the vibration modes in the gyro element with element sensitivity (gyro element sensitivity). FIGS. 4A and 4B show examples of the spectrum representing the correlation of the resonance frequencies in the detection mode 1, the detection mode 2, and the drive mode with the element sensitivity. FIG. 4A shows a case 1, and FIG. 4B shows a case 2. FIGS. 5A and 5B show examples of a spectrum representing the correlation of the degree of detuning in detuning adjustment with the element sensitivity (gyro element sensitivity). FIG. 5A shows the correlation between the degree of detuning and the element sensitivity with reference to the detection mode 2, and FIG. 5B is a graph showing the correlation between the degree of detuning and element sensitivity variation.

The gyro element 300 described above has the following two types of vibration mode: a drive vibration mode (vibration in X-axis direction) in which the drive vibration arms 2a and 2b is driven (allowed to vibrate) at a predetermined resonance frequency (vibration frequency); and a detection vibration mode (vibration in Z-axis direction) in which the detection vibration arms 3a and 3b vibrate in a direction perpendicular to the vibration direction of the drive vibration arms 2a and 2b and detect angular velocity (Coriolis force), as shown in FIG. 3. Further, the detection vibration mode has at least two detection vibration modes in which the pair of detection vibration arms 3a and 3b vibrate in opposite phases.

The detection vibration mode shown in FIG. 3 shows a case where the following two detection vibration modes are present: the detection mode 1 in which the sensitivity peaks at a first resonance frequency (vibration frequency) f1; and the detection mode 2 in which the sensitivity peaks at a second resonance frequency (vibration frequency) f2. In an example of related art, a drive vibration mode having a resonance frequency (vibration frequency) f0 is present between the detection mode 1 and the detection mode 2, but in the present embodiment, a drive vibration mode having a third resonance frequency (vibration frequency) f3, which is a resonance frequency higher than the resonance frequencies in the detection mode 1 and the detection mode 2, is present. The resonance frequency in the drive vibration mode may instead be a fourth resonance frequency (vibration frequency) f4, which is a resonance frequency lower than the resonance frequencies in the detection mode 1 and the detection mode 2.

In the gyro element 300, when the drive vibration arms 2a and 2b are allowed to vibrate at a frequency close to the resonance frequency in any of the detection vibration modes in which angular velocity (Coriolis force) is detected, both the drive vibration arms 2a and 2b and the detection vibration arms 3a and 3b readily vibrate in response to drive vibration (in drive vibration mode), whereby the detection vibration arms 3a and 3b can produce a detection signal of an increased magnitude. That is, the detection sensitivity of the gyro element 300 can be improved.

To cause the resonance frequency of the drive vibration arms 2a and 2b to approach the resonance frequency in a detection vibration mode, the weight sections 52a and 52b as a wide section provided as part of the drive vibration arms 2a and 2b are trimmed, for example, with laser light for mass adjustment. Adjustment of the resonance frequency performed through the mass adjustment is called detuning adjustment. The weight sections 52a and 52b as a wide section thus function as a mass adjustment section, and using the weight sections 52a and 52b as the mass adjustment section allows a wide adjustment range in the detuning adjustment, whereby the size of the vibration element can be reduced and the sensitivity thereof can be increased. Further, the mass adjustment can be performed by trimming the weight sections 52a and 52b as a wide section, whereby the detuning adjustment can be efficiently performed.

In the detuning adjustment, the resonance frequency of one of the two detection vibration modes is fixed, and the resonance frequency in the drive vibration mode is so adjusted that it approaches the fixed resonance frequency. In other words, the detuning adjustment is so performed that the resonance frequency in the drive vibration mode approaches the resonance frequency in one of the two detection vibration modes.

The correlation of the resonance frequencies in the detection mode 1, the detection mode 2, and the drive mode with the element sensitivity will now be described with reference to FIGS. 4A and 4B. First, the case 1 shown in FIG. 4A is, for example, a case where the thickness of the drive vibration arms 2a and 2b increases and/or the width thereof decreases so that the resonance frequency in the drive mode becomes lower than the resonance frequencies in the detection vibration modes. The graph shown in FIG. 4A shows correlation of the resonance frequencies in the detection mode 1, the detection mode 2, and the drive mode with the element sensitivity in the state described above and in a case where the detuning adjustment is performed with reference to the resonance frequency f2 in the detection mode 2 (with the resonance frequency f2 fixed).

In FIG. 4A, a curve Cu1 shows the detection mode 1, the detection mode 2, and the drive mode before the detuning adjustment is performed, and a curve Cu2 shows the detection mode 1, the detection mode 2, and the drive mode after the detuning adjustment is performed (the degree of detuning is changed) in the present case. A curve Cu3 shows the detection mode 1, the detection mode 2, and the drive mode in a case where the detuning adjustment is performed by a greater degree (the degree of detuning is changed by a greater amount).

As shown in FIG. 4A, performing the detuning adjustment changes the resonance frequency f1 in the detection mode 1 (out of drawing range in FIG. 4A) and hence shifts the correlation of the resonance frequencies in the detection mode 1, the detection mode 2, and the drive mode with the element sensitivity from the curve Cu1 to the curve Cu 2 (curve Cu3). Specifically, the curve Cu 2 (curve Cu3) has an increased separation between the element sensitivity at the resonance frequency f2 in the detection mode 2 and the element sensitivity at the resonance frequency f1 in the detection mode 1, and the area where the element sensitivity decreases widens accordingly, whereas in the area where the resonance frequency is higher than the resonance frequency f2, no large change in the element sensitivity occurs. Therefore, in a pattern of related art in which the resonance frequency (vibration frequency) f0 in the drive vibration mode is present between the resonance frequency f1 in the detection mode 1 and the resonance frequency f2 in the detection mode 2, changing the resonance frequency f0 in the drive vibration mode to a resonance frequency f01 undesirably lowers the element sensitivity and increases variation in the element sensitivity. In contrast, in a pattern of the present embodiment in which the drive vibration mode is present at the third resonance frequency (vibration frequency) f3, which is a resonance frequency higher than the resonance frequency f1 in the detection mode 1 and the resonance frequency f2 in the detection mode 2, performing the detuning adjustment in which the resonance frequency f3 in the drive vibration mode is changed to a resonance frequency f31 hardly lowers the element sensitivity, although a slight change in the element sensitivity occurs. Further, variation in the element sensitivity can be suppressed to a small value, whereby stable element sensitivity can be maintained.

The case 2 shown in FIG. 4B will next be described. The case 2 is, for example, a case where the thickness of the drive vibration arms 2a and 2b decreases and/or the width thereof increases so that the resonance frequency in the drive mode becomes higher than the resonance frequencies in the detection vibration modes. The graph shown in FIG. 4B shows correlation of the resonance frequencies in the detection mode 1, the detection mode 2, and the drive mode with the element sensitivity in the state described above and in a case where the detuning adjustment is performed with reference to the resonance frequency f2 in the detection mode 2 (with the resonance frequency f2 fixed). In FIG. 4B, a curve Cu1 shows the detection mode 1, the detection mode 2, and the drive mode before the detuning adjustment is performed, and a curve Cu2 shows the detection mode 1, the detection mode 2, and the drive mode after the detuning adjustment is performed (the degree of detuning is changed) in the present case. A curve Cu3 shows the detection mode 1, the detection mode 2, and the drive mode in a case where the detuning adjustment is performed by a greater degree (the degree of detuning is changed by a greater amount). The curves Cu1, Cu2, and Cu3 will not be described in detail because the descriptions thereof are the same as those in FIG. 4A.

Also in the case 2 shown in FIG. 4B, performing the detuning adjustment in the same manner as in the case 1 undesirably lowers the element sensitivity by a large amount and increases variation in the element sensitivity in the pattern of related art. In contrast, the element sensitivity hardly lowers in the pattern in the present embodiment. Further, in the pattern in the embodiment, since the variation in the element sensitivity can also be suppressed to a small value, whereby stable element sensitivity can be maintained.

A description will next be made of correlation of the degree of detuning in the detuning adjustment with the element sensitivity with reference to FIGS. 5A and 5B. FIG. 5A shows the correlation of the degree of detuning indicated along the horizontal axis in the case where the resonance frequency f2 in the detection mode 2 is fixed with the element sensitivity in the detection mode 1, the detection mode 2, and the drive mode. FIG. 5B shows the correlation of the degree of detuning indicated along the horizontal axis in the case where the resonance frequency f2 in the detection mode 2 is fixed with element sensitivity variation in the detection mode 1, the detection mode 2, and the drive mode.

The correlation of the degree of detuning with the element sensitivity in the detection mode 1, the detection mode 2, and the drive mode behaves in the same manner as the correlation of the resonance frequencies in the detection mode 1, the detection mode 2, and the drive mode with the element sensitivity described above, as shown in FIG. 5A. In FIG. 5A, a curve Cu1 shows the detection mode 1, the detection mode 2, and the drive mode before the detuning adjustment is performed, and a curve Cu2 shows the detection mode 1, the detection mode 2, and the drive mode after the detuning adjustment is performed (the degree of detuning is changed) in the present case. A curve Cu3 shows the detection mode 1, the detection mode 2, and the drive mode in a case where detuning adjustment is performed by a greater degree (the degree of detuning is changed by a greater amount).

As shown in FIG. 5A, performing the detuning adjustment changes the degree of detuning in the detection mode 1 by a large amount (out of drawing range in FIG. 5A) and hence shifts the correlation of the degree of detuning in the detection mode 1, the detection mode 2, and the drive mode with the element sensitivity from the curve Cu1 to the curve Cu 2 (curve Cu3). Specifically, the curve Cu 2 (curve Cu3) has an increased separation between the element sensitivity in the detection mode 2 and the element sensitivity in the detection mode 1 in the area where the degree of detuning is negative (−), and the area where the element sensitivity decreases widens accordingly, whereas in the area where the degree of detuning is positive (+), no large change in the element sensitivity occurs although it slightly changes. Therefore, in the pattern of related art in which the drive vibration mode is present between the detection mode 1 and the detection mode 2, the detuning adjustment undesirably lowers the element sensitivity by a large amount and increases variation in the element sensitivity. In contrast, in the pattern of the present embodiment in which the drive mode is present in a position where the degree of detuning in the drive mode is greater than those in the detection mode 1 and the detection mode 2, performing the detuning adjustment hardly lowers the element sensitivity. Further, variation in the element sensitivity can be suppressed to a small value, whereby stable element sensitivity can be maintained.

Further, the degree of detuning correlates with the element sensitivity variation in the detection mode 1, the detection mode 2, and the drive mode as indicated by a curve Cu5 and a curve Cu6 shown in FIG. 5B. The curve Cu5 shows the correlation in a case where the degree of detuning has positive (+) values with respect to the detection mode 2 (degree of detuning: 0%), which is the reference, and demonstrates that the element sensitivity variation quadratically increases as the degree of detuning shifts toward the positive (+) side. The curve Cu6 shows the correlation in a case where the degree of detuning has negative (−) values with respect to the detection mode 2 (degree of detuning: 0%), which is the reference, and demonstrates that the element sensitivity variation quadratically increases as the degree of detuning shifts toward the negative (−) side. That is, when the absolute value of the degree of detuning in the detuning adjustment is greater than or equal to 0.5% but smaller than or equal to 8%, the element sensitivity variation can be suppressed to a small value.

The case where the degree of detuning has negative (−) values with respect to the detection mode 2 (degree of detuning: 0%), which is the reference, corresponds to the pattern in which the drive vibration mode is present at the third resonance frequency (vibration frequency) f3, which is a resonance frequency higher than the resonance frequency f1 in the detection mode 1 and the resonance frequency f2 in the detection mode 2. The case where the degree of detuning has positive (+) values with respect to the detection mode 2 (degree of detuning: 0%), which is the reference, corresponds to the pattern in which the drive vibration mode is present at the fourth resonance frequency (vibration frequency) f4 (see FIG. 3), which is a resonance frequency lower than the resonance frequency f1 in the detection mode 1 and the resonance frequency f2 in the detection mode 2.

Setting the absolute value of the degree of detuning in the detuning adjustment, in which the resonance frequency f3 of the drive vibration arms 2a and 2b (see FIGS. 4A and 4B) is caused to approach the resonance frequency f2 of the detection vibration arms 3a and 3b (see FIGS. 4A and 4B), to fall within the range from 0.5% to 8% allows suppression of decrease in the detection sensitivity and suppression of variation in the detection sensitivity due, for example, to the trimming in the detuning adjustment, as shown in FIG. 5B. The reason for this is that setting the drive vibration mode to be present in the area where the curve Cu1 and the curve Cu2 (Cu3) (detection sensitivity spectra) change by small amounts in the detuning adjustment allows the element sensitivity variation due to a change in the degree of detuning to be also small.

As described above, in the gyro element 300, which has the pattern in which the drive vibration mode is present at the third resonance frequency (vibration frequency) f3, which is a resonance frequency higher than the resonance frequency f1 in the detection mode 1 and the resonance frequency f2 in the detection mode 2, performing the detuning adjustment, in which the resonance frequency f3 in the drive vibration mode is changed to the resonance frequency f31, hardly lowers the element sensitivity although a slight change in the element sensitivity occurs. Further, the element sensitivity variation can also be suppressed to a small value, whereby stable element sensitivity can be maintained. Similarly, also in the pattern in which the drive vibration mode is present at the fourth resonance frequency (vibration frequency) f4, which is a resonance frequency lower than the resonance frequency f1 in the detection mode 1 and the resonance frequency f2 in the detection mode 2, the detuning adjustment hardly lowers the element sensitivity although a slight change in the element sensitivity occurs. Further, the element sensitivity variation can also be suppressed to a small value, whereby stable element sensitivity can be maintained.

The gyro element 300 according to the above first embodiment has been described with reference to the case where the pair of detection vibration arms 3a and 3b and the pair of adjustment vibration arms 4a and 4b, which sandwich the detection vibration arms 3a and 3b, are provided on one end of the base section 1 and the pair of drive vibration arms 2a and 2b are provided on the other end of the base section 1, but the configuration described above is not necessarily employed. For example, the drive vibration arms and the adjustment vibration arms may extend from the same end of the base section in the same direction.

### Second Embodiment

### Gyro Element-2

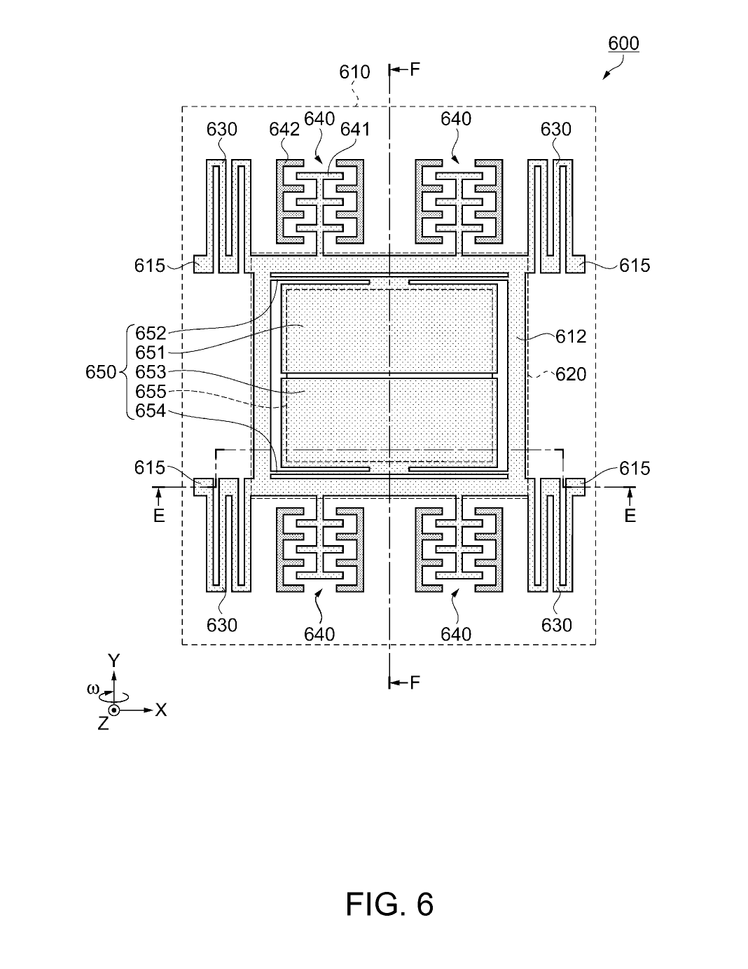

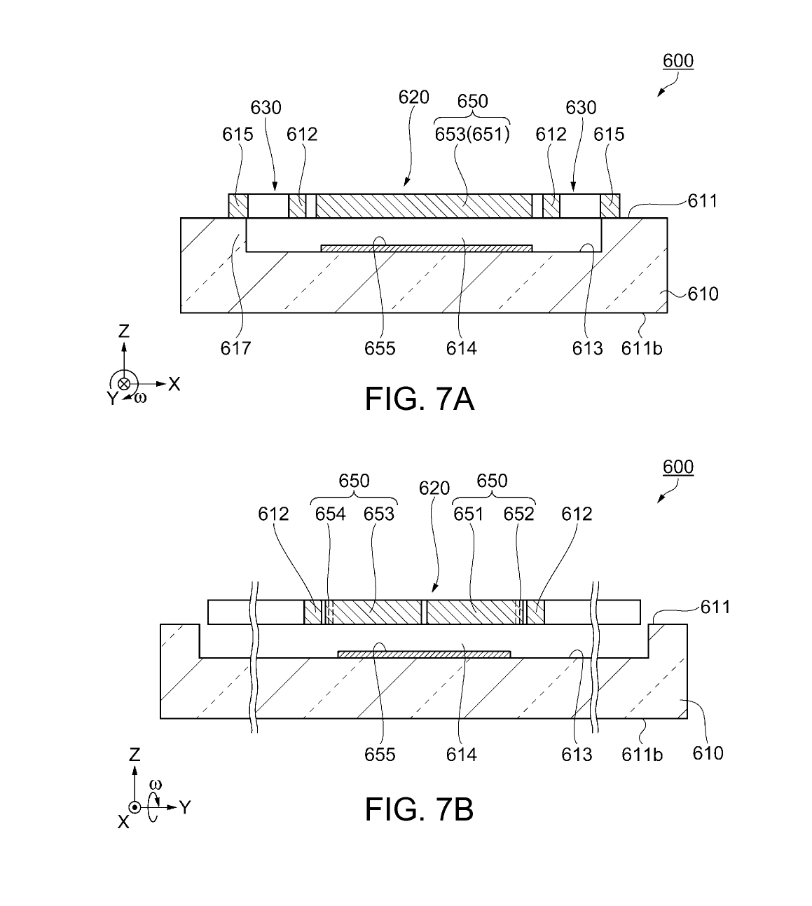

A gyro element 600 will next be described with reference to FIG. 6. FIG. 6 is a plan view schematically showing the gyro element 600 as an example of an vibration element according to a second embodiment. FIGS. 7A and 7B schematically show the gyro element 600 according to the second embodiment. FIG. 7A is a cross-sectional view taken along the line E-E in FIG. 6, and FIG. 7B is a cross-sectional view taken along the line F-F in FIG. 6.

The gyro element 600 includes a base body 610, an vibration body 620, elastic support bodies 630, and drive sections 640, as shown in FIG. 6 and FIGS. 7A and 7B. In the gyro element 600, the vibration body 620 is provided via a recess 614 provided in the base body 610 and a gap. The vibration body 620 is supported by a fixing section 617, which is provided as part of a first surface 611 of the base body 610 (on base body 610), via the elastic support bodies 630. A portion including the vibration body 620, the elastic support bodies 630, and part of the drive sections 640 (driving movable electrode portions 641) corresponds to the drive vibration section.

The gyro element 600 is a gyro element in which a detection section 650 of the vibration body 620 detects angular velocity around the Y axis (electrostatic capacitance MEMS gyro element). In FIG. 6, the base body 610 is drawn in a perspective form for convenience. Viewing along the direction of a normal to the first surface 611 (see FIGS. 7A and 7B), which is a base surface which is a surface of the base body 610 and on which the vibration body 620 is provided, that is, viewing the vibration body 620 supported by the base body 610 from above is hereinafter referred to as “plan view.”

The base body 610 has the first surface 611 and a second surface 611b, which faces away from the first surface 611, as shown in FIGS. 7A and 7B. The recess 614 is provided with through the first surface 611. Above the recess 614 are provided the vibration body 620 (detection section 650 and support section 612), the elastic support bodies 630, and the drive sections 640 (driving movable electrode portions 641 and driving fixed electrode portions 642) with a gap between the recess 614 and the components described above. The recess 614 allows the vibration body 620, the elastic support bodies 630, and part of the drive sections 640 (driving movable electrode portions 641) to be movable in a desired direction without interference with the base body 610. The base body 610 can be made, for example, of glass or silicon. The recess 614 in the present embodiment has an oblong shape in the plan view (shape viewed in Z-axis direction) but does not necessarily have a specific shape. The recess 614 is formed, for example, by using photolithography and etching technologies.

The base body 610 has the fixing section 617 provided as part of the first surface 611 as appropriate in accordance with the form of the vibration body 620, as shown in FIGS. 7A and 7B. The fixing section 617 is a portion to which one end 615 of each of the elastic support bodies 630, which support the vibration body 620, is fixed (bonded) and which supports the vibration body 620 via the elastic support bodies 630. The one end 615 of each of the elastic support bodies 630 (fixing section 617) may instead be so disposed that it sandwiches the vibration body 620 in the X-axis direction. Still instead, the one end 615 of each of the elastic support bodies 630 may be so disposed that it sandwiches the vibration body 620 in the Y-axis direction. That is, the one end 615 of each of the elastic support bodies 630 may be formed of two or four ends 615.

A method for fixing (bonding) the first surface 611 of the fixing section 617 (base body 610) to the elastic support bodies 630, the driving fixed electrode portions 642, and other portions is not limited to a specific method and can, for example, be anodic bonding in a case where the base body 610 is made of glass and the vibration body 620 and other portions are made of silicon.

The vibration body 620 is supported by the first surface 611 of the base body 610 (on base body 610) via the elastic support bodies 630. The vibration body 620 has the detection section 650 and the support section 612 connected to the detection section 650. The vibration body 620 is made, for example, of silicon into which phosphorous, boron, or any other impurity is doped so that conductivity is imparted to the vibration body 620. The vibration body 620 is formed, for example, by processing a silicon substrate (not shown) by using photolithography and etching technologies.

The vibration body 620 is supported by the fixing section 617 via the elastic support bodies 630, specifically, the one end 615 of each of the elastic support bodies 630 so that the vibration body 620 is set apart from the base body 610. More specifically, the vibration body 620 is provided via a gap above the recess 614 formed in the base body 610. The vibration body 620 has the frame-shaped (frame-like) support section 612, which surrounds the detection section 650, which will be described later. The vibration body 620 may instead have a symmetric shape with respect to a center line that is not shown (straight line along X axis or straight line along Y axis).

The elastic support bodies 630 are so configured that it can displace the vibration body 620 in the X-axis direction. More specifically, each of the elastic support bodies 630 has a shape that extends in the direction along the X axis from the one end 615 of the elastic support body 630 to the vibration body 620 while extending back and forth in the Y-axis direction. The one end 615 of each of the elastic support bodies 630 is bonded (fixed) to the fixing section 617 (first surface 611 of base body 610). The other end of each of the elastic support bodies 630 is connected to the support section 612 of the vibration body 620. In the present embodiment, the elastic support bodies 630 are formed of four elastic support bodies 630 that sandwich the vibration body 620 in the X-axis direction.

The elastic support bodies 630 are made, for example, of silicon into which phosphorous, boron, or any other impurity is doped so that conductivity is imparted to the vibration body 620. The elastic support bodies 630 are formed integrally with the vibration body 620, for example, by processing a silicon substrate (not shown) by using photolithography and etching technologies.

The detection section 650 is provided inside the support section 612 of the vibration body 620 (in central portion of vibration body 620) in the plan view. In other words, the detection section 650 is provided on the opposite side of the support section 612 to the side where the drive sections 640, which will be described later, are disposed. The detection section 650 includes a first flap plate 651 and a second flap plate 653, each of which serves as a movable electrode, a first beam 652, which is connected to the first flap plate 651, a second beam 654, which is connected to the second flap plate 653, and a detecting fixed electrode 655. The first flap plate 651 and the second flap plate 653 are made, for example, of silicon into which phosphorous, boron, or any other impurity is doped so that conductivity is imparted to the first flap plate 651 and the second flap plate 653, as described above. A portion including the first flap plate 651 and the first beam 652, which is connected to the first flap plate 651, and the second flap plate 653 and the second beam 654, which is connected to the second flap plate 653, corresponds to the detection vibration section.

The first flap plate 651 is connected to the first beam 652 at a connection section located in a central portion of the first beam 652 in the X-axis direction. The first beam 652 is provided along part an extending portion of the support section 612 located on one side and extending along the X axis, and opposite ends of the first beam 652 are connected to two extending portions of the support section 612 that extend along the Y axis and face each other. The end of the first flap plate 651 that is opposite the end thereof connected to the first beam 652 is a free end. The first flap plate 651 is swingable in the Z-axis direction around the first beam 652, which serves as the axis of rotation.

The second flap plate 653 is connected to the second beam 654 at a connection portion located in a central portion of the second beam 654 in the X-axis direction. The second beam 654 is provided along the extending portion of the support section 612 on one side or the side facing the first beam 652 (the side in the +Y-axis direction) and along an extending portion of the support section 612 on the other side or the opposite side of the detection section 650 (the side in the −Y-axis direction).

Opposite ends of the second beam 654 are connected to the inner sides of the two extending portions of the support section 612 that face each other along the Y-axis direction. The end of the second flap plate 653 that is opposite the end thereof connected to the second beam 654 is a free end. The second flap plate 653 is swingable in the Z-axis direction around the second beam 654, which serves as the axis of rotation. The free ends of the first flap plate 651 and the second flap plate 653 are so provided that they are oriented inward in the Y-axis direction and face each other with a gap therebetween.

The detecting fixed electrode 655 is so provided that it faces the first flap plate 651 and the second flap plate 653 with a gap and roughly coincides in the plan view with the area where the first flap plate 651 and the second flap plate 653 are disposed. The detecting fixed electrode 655 is provided on a bottom surface 613 of the recess 614 provided in the base body 610 through the first surface 611.

The detecting fixed electrode 655 provided on the bottom surface 613 of the recess 614 in the base body 610 is formed, for example, by depositing ITO (indium tin oxide), ZnO (zinc oxide), or any other transparent electrode material to forma film, for example, in a sputtering process and patterning the film, for example, in photolithography and etching processes. The detecting fixed electrode 655 is not necessarily made of a transparent electrode material and can be made of gold (Au), a gold alloy, platinum (Pt), aluminum (Al), an aluminum alloy, silver (Ag), a silver alloy, chromium (Cr), a chromium alloy, copper (Cu), molybdenum (Mo), niobium (Nb), tungsten (W), iron (Fe), titanium (Ti), cobalt (Co), zinc (Zn), zirconium (Zr), or any other metal material. When the base body 610 is made of a semiconductor material, such as silicon, it is preferable to provide an insulating layer between the base body 610 and the detecting fixed electrode 655. The insulating layer can be made, for example, of SiO₂ (silicon oxide), AlN (aluminum nitride), or SiN (silicon nitride).

The drive sections 640 have a mechanism capable of exciting the vibration body 620. The configuration of the drive sections 640 and the number of drive section 640 are not specifically limited as long as the vibration body 620 can be excited. For example, the drive sections 640 may be directly provided in the vibration body 620. Each of the drive sections 640 is formed of the driving movable electrode portion 641, which is connected to the outer side of the vibration body 620 (support section 612) in the Y-axis direction, and the driving fixed electrode portions 642, which are so disposed on the base body 610 that they face the driving movable electrode portion 641 with a predetermined distance, as shown in FIG. 6. The drive sections 640 may instead have a mechanism that is not directly connected to the vibration body 620 but excites the vibration body 620, for example, with electrostatic force and may be disposed outside the vibration body 620.

The driving movable electrode portion 641 may be formed of a plurality of driving movable electrode portions 641 connected to the vibration body 620. In the example shown in FIG. 6, each of the driving movable electrode portions 641 is provided in the form of a comb-shaped electrode having a stem portion extending from the vibration body 620 in the +Y-axis direction (or −Y-axis direction) and a plurality of branch portions extending from the stem portion in the +X-axis and −X-axis directions.

The driving fixed electrode portions 642 are disposed outside the driving movable electrode portion 641. The driving fixed electrode portions 642 are bonded (fixed) to the first surface 611 of the base body 610. In the example shown in FIG. 6, the driving fixed electrode portion 642 is formed of a plurality of driving fixed electrode portions 642, which are so disposed that they face each other via the driving movable electrode portion 641. When the driving movable electrode portion 641 has a comb-like shape, each of the driving fixed electrode portions 642 may be so shaped that it is a comb-shaped electrode corresponding to the driving movable electrode portion 641.

The drive sections 640 are made of silicon into which phosphorous, boron, or any other impurity is doped so that conductivity is imparted to the drive sections 640. The drive sections 640 are formed integrally with the vibration body 620, for example, by processing a silicon substrate (not shown) by using photolithography and etching technologies.

The thus configured gyro element 600 detects angular velocity ω around the Y axis as follows: When the gyro element 600 is so driven that it vibrates in a state in which no angular velocity ω acts thereon, electrostatic force produced between the driving fixed electrode portions 642 and the driving movable electrode portion 641 in each of the drive sections 640 connected to the support section 612 causes the vibration body 620 to make reciprocating vibration (motion) along the X axis. More specifically, AC voltage is applied between the driving fixed electrode portions 642 and the driving movable electrode portion 641. The vibration body 620, which includes the first flap plate 651, the second flap plate 653, and other portions, is thus allowed to vibrate along the X axis at a predetermined frequency.

In a state in which the gyro element 600 is so driven that it vibrates, when the angular velocity ω around the Y axis acts on the gyro element 600, Coriolis force in the Z-axis direction is produced and causes the vibration body 620 (first flap plate 651 and the second flap plate 653) to vibrate in the Z-axis direction. A change in capacitance resulting from the vibration in the Z-axis direction is detected for calculation of the angular velocity. Specifically, in a state in which DC voltage is applied to the first flap plate 651 and the second flap plate 653, when the first flap plate 651 and the second flap plate 653 vibrate (swing) in the Z-axis direction, the distance between the first flap plate 651/the second flap plate 653 and the detecting fixed electrode 655 changes, and the electrostatic capacitance between the first flap plate 651/the second flap plate 653 and the detecting fixed electrode 655 changes accordingly. The change in the capacitance can be detected in the form of a change in current flowing through the detecting fixed electrode 655 for determination of the angular velocity ω.

The vibration mode of the gyro element 600 will next be described. In the following description, it is assumed that a portion including the vibration body 620, the elastic support bodies 630, part of the drive sections 640 (driving movable electrode portions 641) is the drive vibration section and a portion including the first flap plate 651 and the first beam 652, which is connected to the first flap plate 651, and the second flap plate 653 and the second beam 654, which is connected to the second flap plate 653, is the detection vibration section.

The gyro element 600 also has the following two types of vibration mode: a drive vibration mode (vibration in X-axis direction) in which the drive vibration section is driven (caused to vibrate) at a predetermined resonance frequency (vibration frequency); and a detection vibration mode (vibration in Z-axis direction) in which the detection vibration section vibrates in a direction perpendicular to the vibration direction of the drive vibration section and detects angular velocity (Coriolis force), as the gyro element 300 according to the first embodiment described above shown in FIG. 3. Further, the detection vibration mode has at least two detection vibration modes in which the first flap plate 651 and the second flap plate 653 vibrate in opposite phases. The detection mode is the same as the detection mode described in the first embodiment and is not therefore described in detail. It is, however, noted that the following two detection vibration modes are present also in the present embodiment: the detection mode 1 in which the sensitivity peaks as the first resonance frequency (vibration frequency) f1; and the detection mode 2 in which the sensitivity peaks as the second resonance frequency (vibration frequency) f2. The drive vibration mode is then present at the third resonance frequency (vibration frequency) f3, which is a resonance frequency higher than the resonance frequencies in the detection mode 1 and the detection mode 2. The drive vibration mode may instead be present at the fourth resonance frequency (vibration frequency) f4, which is a resonance frequency lower than the resonance frequencies in the detection mode 1 and the detection mode 2.

In the gyro element 600, when the drive vibration section is allowed to vibrate at a frequency close to the resonance frequency in any of the detection vibration modes in which angular velocity (Coriolis force) is detected, both the drive vibration section and the detection vibration section readily vibrate in response to drive vibration (drive vibration mode), and the detection vibration section can produce a detection signal having an increased magnitude. That is, the detection sensitivity of the gyro element 600 can be improved.

To cause the resonance frequency of the drive vibration section to approach the resonance frequency in any of the detection vibration modes, mass adjustment in which the mass of the drive vibration sections is adjusted, that is, the detuning adjustment is performed. In the detuning adjustment, the resonance frequency in one of the two detection vibration modes is fixed, and the resonance frequency in the drive vibration mode is so adjusted that it approaches the fixed resonance frequency, as in the first embodiment described above. In other words, the detuning adjustment is so performed that the resonance frequency in the drive vibration mode approaches the resonance frequency in one of the two detection vibration modes.

The correlation of the resonance frequencies in the detection mode 1, the detection mode 2, and the drive mode with the element sensitivity in the detuning adjustment is the same as the correlation in the first embodiment described above with reference to FIGS. 4A and 4B and FIGS. 5A and 5B and will therefore not be described. The gyro element 600 according to the present embodiment also provides the same advantageous effects as those provided by the gyro element 300 according to the first embodiment described above. In detail, since the gyro element 600 also employs the pattern in which the drive vibration mode is present at the third resonance frequency (vibration frequency) f3, which is a resonance frequency higher than the resonance frequency f1 in the detection mode 1 and the resonance frequency f2 in the detection mode 2, which are shown in FIGS. 4A and 4B and FIGS. 5A and 5B, performing the detuning adjustment, in which the resonance frequency f3 in the drive vibration mode is changed to the resonance frequency f31, hardly lowers the element sensitivity although a slight change in the element sensitivity occurs. Further, variation in the element sensitivity can be suppressed to a small value, whereby stable element sensitivity can be maintained.

Further, the correlation of the degree of detuning with the element sensitivity variation in the detection mode 1, the detection mode 2, and the drive mode is also the same as the correlation in the first embodiment described above and will not therefore be described. When the absolute value of the degree of detuning in the detuning adjustment falls within the range from 0.5% to 8%, the element sensitivity variation can be suppressed to a small value.

As described above, according to the gyro element 600, since the drive vibration mode is present at the third resonance frequency (vibration frequency) f3, which is a resonance frequency higher than the resonance frequency f1 in the detection mode 1 and the resonance frequency f2 in the detection mode 2, performing the detuning adjustment, in which the resonance frequency f3 in the drive vibration mode is changed to the resonance frequency f31, hardly lowers the element sensitivity although a slight change in the element sensitivity occurs. Further, the element sensitivity variation can be suppressed to a small value, whereby stable element sensitivity can be maintained. Similarly, also in the pattern in which the drive vibration mode is present at the fourth resonance frequency (vibration frequency) f4, which is a resonance frequency lower than the resonance frequency f1 in the detection mode 1 and the resonance frequency f2 in the detection mode 2, performing the detuning adjustment hardly lowers the element sensitivity although a slight change in the element sensitivity occurs. Further, the element sensitivity variation can be suppressed to a small value, whereby stable element sensitivity can be maintained.

### Gyro Sensor as Electronic Device

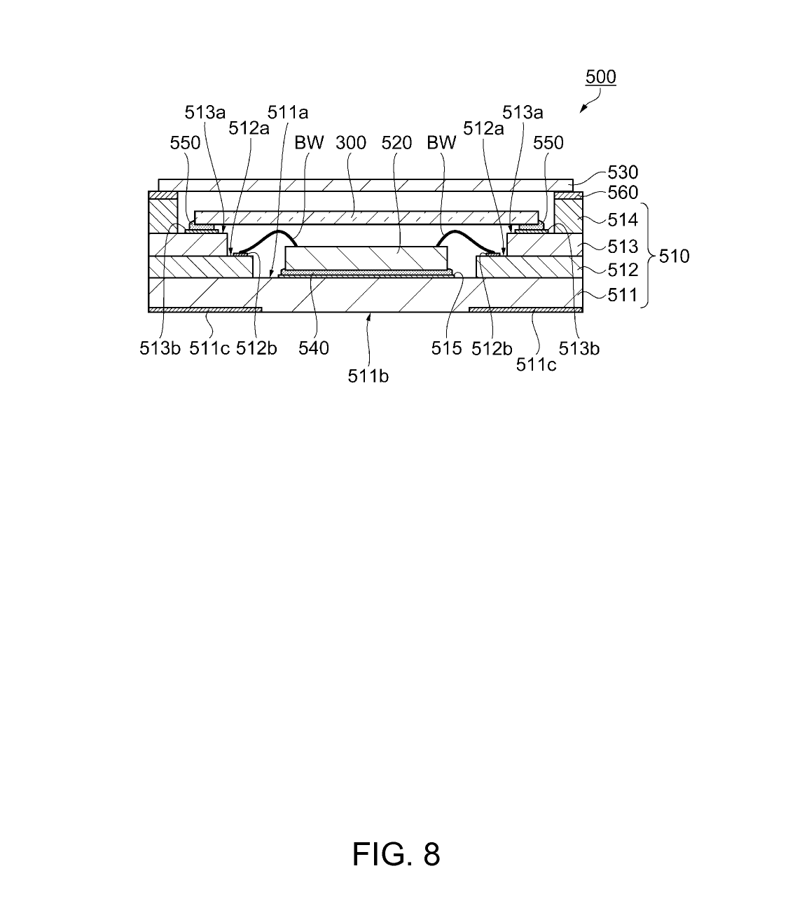

A gyro sensor as an electronic device including the gyro element 300 according to the first embodiment will next be described with reference to FIG. 8. FIG. 8 is a front cross-sectional view schematically showing the gyro sensor as an example of the electronic device.

A gyro sensor 500 includes the gyro element 300 and a semiconductor device 520 as a circuit section that are accommodated in a recess of a package 510, and a lid 530 hermetically seals the opening of the package 510 so that the interior of the package 510 is hermetically maintained, as shown in FIG. 8. The package 510 is formed by sequentially stacking a first substrate 511, which has a flat-plate-like shape, and a second substrate 512, a third substrate 513, and a fourth substrate 514, each of which has a frame-like shape, on each other and firmly fixing the substrates to each other, and a recess that accommodates the semiconductor device 520 and the gyro element 300 is thus formed. Each of the substrates 511, 512, 513, and 514 is made, for example, of a ceramic material.

The first substrate 511 has an electronic part mounting surface 511a, which is located on the side where the recess is present and on which the semiconductor device 520 is mounted, and a die pad 515, on which the semiconductor device 520 is placed and to which the semiconductor device 520 is fixed, is provided on the electronic part mounting surface 511a. The semiconductor device 520 is glued and fixed onto the die pad 515, for example, with a brazing material (die attaching material) 540.

The semiconductor device 520 as a circuit section includes a drive circuit as an exciter for driving the gyro element 300 to cause it to vibrate and a detection circuit as a detector for detecting detection vibration produced in the gyro element 300 when angular velocity acts thereon. Specifically, the drive circuit provided in the semiconductor device 520 supplies drive signals to the drive electrodes 11a, 11b, and 12c and the drive electrodes 11c, 12a, and 12b (see FIG. 2B) formed on the pair of drive vibration arms 2a and 2b (see FIGS. 1A and 1B) of the gyro element 300. The detection circuit provided in the semiconductor device 520 amplifies detection signals produced by the detection electrodes 21a, 21b, 22a, and 22b and the detection electrodes 31a, 31b, 32a, and 32b (see FIG. 2A) formed on the pair of detection vibration arms 3a and 3b of the gyro element 300 to produce amplified signals and detects the rotational angular velocity having acted on the gyro sensor 500 based on the amplified signals.

The second substrate 512 has a frame-like shape having an opening that can accommodate the semiconductor device 520 mounted on the die pad 515. The third substrate 513 has a frame-like shape having an opening larger than the opening of the second substrate 512 and is layered on and fixed to the second substrate 512. A second substrate surface 512a, which appears through the opening of the third substrate 513 layered on the second substrate 512, has a plurality of IC connection terminals 512b, to which bonding wires BW, which are electrically connected to electrode pads of the semiconductor device 520 that are not shown, are connected. The electrode pads of the semiconductor device 520 that are not shown are then electrically connected to the IC connection terminals 512b provided in the package 510 in a wire bonding process. That is, the plurality of electrode pads provided on the semiconductor device 520 are connected to the corresponding IC connection terminals 512b in the package 510 via the bonding wires BW. Some of the IC connection terminals 512b are electrically connected to a plurality of outer connection terminals 511c provided on an outer bottom surface 511b of the first substrate 511 via internal wiring lines in the package 510 that are not shown.

The fourth substrate 514, which has an opening larger than the opening of the third substrate 513, is layered on and fixed to the third substrate 513. A third substrate surface 513a, which appears through the opening of the fourth substrate 514 layered on the third substrate 513, has a plurality of gyro element connection terminals 513b to be connected to connection pads (not shown) formed on the gyro element 300. The gyro element connection terminals 513b are electrically connected to some of the IC connection terminals 512b with internal wiring lines in the package 510 that are not shown. The first support section 5b and the second support section 6b (see FIGS. 1A and 1B) of the gyro element 300 are placed on the third substrate surface 513a, with the connection pads aligned with the gyro element connection terminals 513b, and glued and fixed to the third substrate surface 513a with a conductive adhesive 550.

Further, the lid 530 is placed on the upper surface of the fourth substrate 514 over the opening thereof, so that the opening of the package 510 is sealed and the interior of the package 510 is hermetically sealed. The gyro sensor 500 is thus produced. The lid 530 can be made, for example, of 42 alloy (alloy in which iron contains nickel by 42%), kovar (alloy of iron, nickel, and cobalt), or any other metal, a ceramic material, or a glass material. For example, when the lid 530 is made of a metal, the lid 530 is bonded to the package 510 in seam welding via a seal ring 560, which is made, for example, of a cobalt alloy and shaped by using a mold into a rectangular ring shape. Since the recessed space formed by the package 510 and the lid 530 is a space where the gyro element 300 operates, the space is preferably a reduced-pressure space or a space with an inert gas atmosphere encapsulated and sealed therein.

The gyro sensor 500 as the electronic device, which includes the gyro element 300 capable of suppressing variation in the element sensitivity to a small value and maintaining stable element sensitivity, has a stable sensing characteristic. Further, the gyro sensor 500 of the package type having the configuration described above is advantageous in reduction in size and thickness and capable of increasing impact resistance.

Examples of the electronic device in which the vibration element according to any of the embodiments of the invention may include a sensing device and a timing device as well as the gyro sensor 500.

### Electronic Apparatus

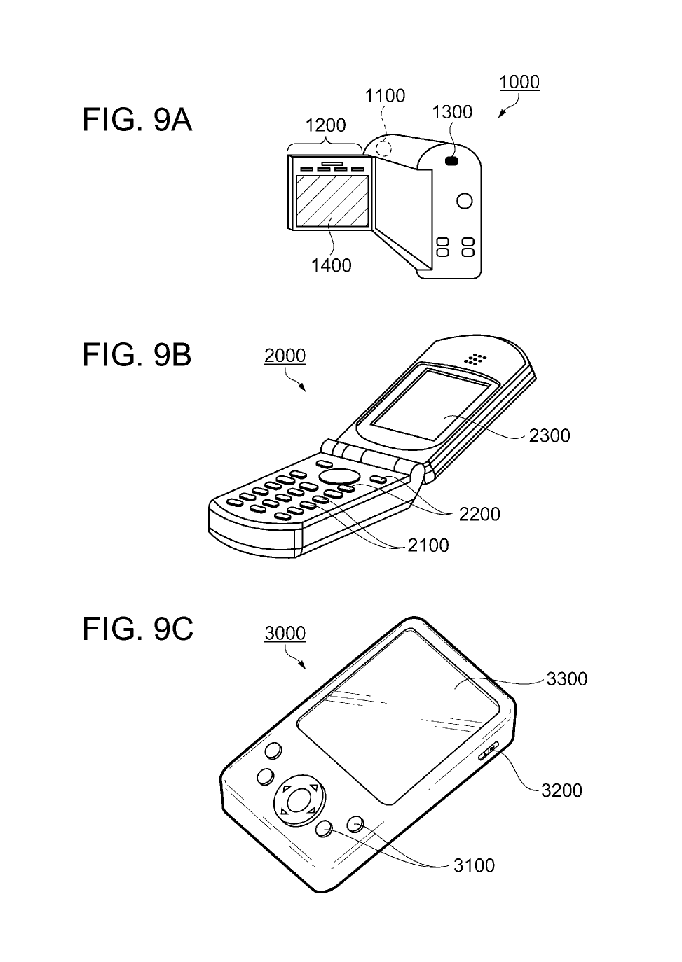

Electronic apparatus including the vibration element according to any of the embodiments described above will next be described with reference to FIGS. 9A to 9C. The following description will be made of examples using the gyro element 300 as an example of the vibration element. FIGS. 9A to 9C are perspective views showing examples of the electronic apparatus including the gyro element 300.

FIG. 9A shows an example in which the gyro element 300 is used in a digital video camcorder 1000 as the electronic apparatus. The digital video camcorder 1000 includes an image receiving section 1100, an operation section 1200, a voice input section 1300, and a display unit 1400. The thus configured digital video camcorder 1000, in which the gyro element 300 according to the embodiment described above is incorporated, can provide what is called a hand-shake correction function.

FIG. 9B shows an example in which the gyro element 300 is used in a mobile phone 2000 as the electronic apparatus. The mobile phone 2000 shown in FIG. 9B includes a plurality of operation buttons 2100 and scroll buttons 2200 and a display unit 2300. When a user operates any of the scroll buttons 2200, a screen displayed on the display unit 2300 is scrolled.

FIG. 9C shows an example in which the gyro element 300 is used in a personal digital assistant (PDA) 3000 as the electronic apparatus. The PDA 3000 shown in FIG. 9C includes a plurality of operation buttons 3100, a power switch 3200, and a display unit 3300. When a user operates the power switch 3200, an address book, a schedule card, and a variety of other pieces of information are displayed on the display unit 3300.

When the gyro element 300 according to the embodiment described above is incorporated in the mobile phone 2000 and the PDA 3000, a variety of functions can be achieved. For example, when the mobile phone 2000 shown in FIG. 9B is provided with a camera function that is not shown, hand-shake correction can be performed as in the digital video camcorder 1000 described above. When the mobile phone 2000 shown in FIG. 9B or the PDA 3000 shown in FIG. 9C is provided with a widely known global positioning system (GPS), incorporating the gyro element 300 according to the embodiment described above in the mobile phone 2000 or the PDA 3000 allows the GPS to recognize the position and attitude thereof.

The vibration element that is, for example, the gyro element 300 according to the embodiment of the invention can be used not only in the digital video camcorder 1000 shown in FIG. 9A, the mobile phone shown in FIG. 9B, and the personal digital assistant shown in FIG. 9C but also in electronic apparatus, such as an inkjet-type liquid ejection apparatus (inkjet printer, for example), a laptop personal computer, a television receiver, a video camcorder, a video tape recorder, a car navigator, a pager, an electronic notepad (including electronic notepad having communication capability), an electronic dictionary, a desktop calculator, an electronic game console, a word processor, a workstation, a TV phone, a security television monitor, electronic binoculars, a POS terminal, a medical apparatus (electronic thermometer, blood pressure gauge, blood sugar meter, electrocardiograph, ultrasonic diagnostic apparatus, and electronic endoscope, for example), a fish finder, a variety of measuring apparatus, a variety of instruments (instruments in vehicles, airplanes, and ships, for example), and a flight simulator.

### Moving Object

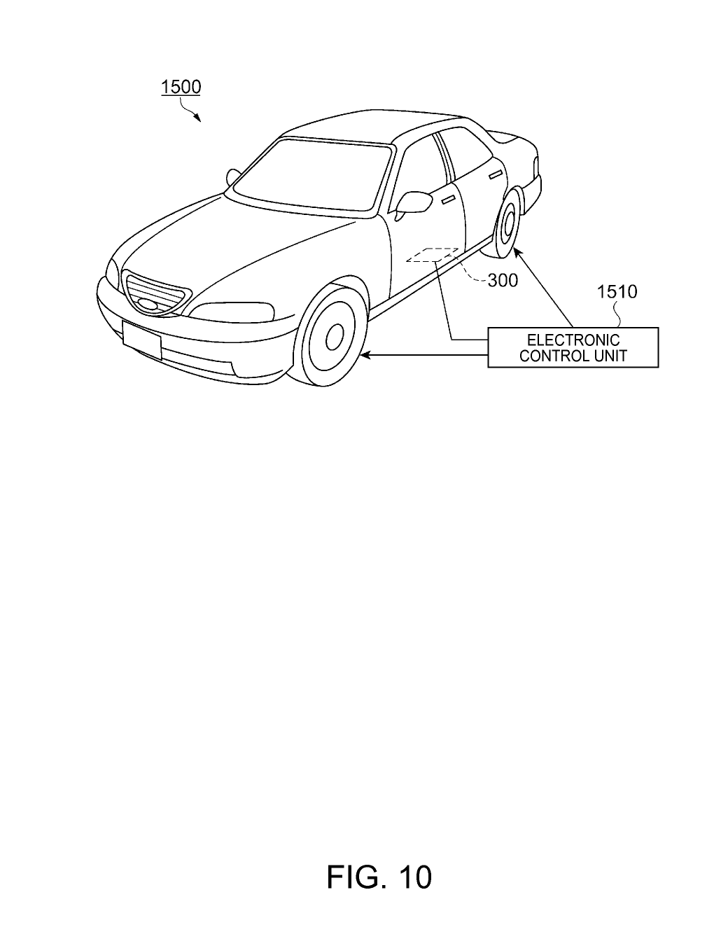

A moving object including the vibration element according to any of the embodiments described above will next be described. The following description will be made of an example using the gyro element 300 as an example of the vibration element. FIG. 10 is a perspective view schematically showing an automobile as an example of the moving object. An automobile 1500 has the gyro element 300 incorporated therein. For example, in the automobile 1500 as the moving object, a vehicle body thereof incorporates an electronic control unit 1510, in which the gyro element 300 is built in and which controls wheels and other component, as shown in FIG. 10. The gyro element 300 can also be widely used as a keyless entry system, an immobilizer, a car navigation system, a car air conditioner, an anti-lock braking system (ABS), an airbag, a tire pressure monitoring system (TPMS), an engine control system, an apparatus that monitors a battery in a hybrid automobile and an electric automobile, a vehicle body attitude control system, or any other electronic control unit (ECU).

The invention has been specifically described with reference to the embodiments but is not limited to the embodiment described above, and a variety of changes can be made thereto to the extent that the changes do not depart from the substance of the invention. For example, the above embodiments and variations have been described with reference to the case where the vibration element or the gyro element as the vibration element is made of quartz, but a piezoelectric material other than quartz can instead be used. For example, a layered piezoelectric substrate produced by layering a piezoelectric material, such as an aluminum nitride or tantalum pentoxide (Ta₂O₅), is layered on a substrate made of an oxide, such as an aluminum nitride (AlN), a lithium niobate (LiNbO₃), a lithium tantalate (LiTaO₃), lead zirconate titanate (PZT), lithium tetraborate (Li₂B₄O₇), and Langasite (La₃Ga₅SiO₁₄) or a substrate made of glass, or a piezoelectric ceramic material can be used. Further, the vibration element can be formed by using a material other than a piezoelectric material. For example, the vibration element can be formed by using a silicon semiconductor material or any other material. Further, how to cause the vibration element to vibrate (how to drive vibration element) is not limited to a piezoelectric-based driving method. An vibration element driven based on an electrostatic drive method using electrostatic force, a Lorentz drive method using magnetic force, and other methods as well as the piezoelectric drive method using a piezoelectric substrate can be configured according to the invention and allowed to provide advantageous effects thereof.

The entire disclosure of Japanese Patent Application No. 2014-221155, filed Oct. 30, 2014 is expressly incorporated by reference herein.

What is claimed is:

1. An vibration element comprising:
a drive vibration section; and
a detection vibration section that resonates with Coriolis force produced in the drive vibration section and vibrates,
wherein the detection vibration section has a detection mode 1 and a detection mode 2 as an vibration mode for detection, and
an vibration frequency of the drive vibration section is higher than an vibration frequency in the detection mode 1 and an vibration frequency in the detection mode 2, or the vibration frequency of the drive vibration section is lower than the vibration frequency in the detection mode 1 and the vibration frequency in the detection mode 2.

2. The vibration element according to claim 1,
wherein a degree of detuning between the vibration frequency of the drive vibration section and the vibration frequency of the detection vibration section is
greater than or equal to −8% but smaller than or equal to −0.5% when the vibration frequency of the drive vibration section is higher than the vibration frequency in the detection mode 1 and the vibration frequency in the detection mode 2, whereas
greater than or equal to 0.5% but smaller than or equal to 8% when the vibration frequency of the drive vibration section is lower than the vibration frequency in the detection mode 1 and the vibration frequency in the detection mode 2.

3. The vibration element according to claim 1,
further comprising a base section,
wherein the drive vibration section and the detection vibration section extend from the base section, and
at least one of the drive vibration section and the detection vibration section has one end connected to the base section and a wide section provided at another end of the vibration section that faces away from the one end.

4. The vibration element according to claim 2,
further comprising a base section,
wherein the drive vibration section and the detection vibration section extend from the base section, and
at least one of the drive vibration section and the detection vibration section has one end connected to the base section and a wide section provided at another end of the vibration section that faces away from the one end.

5. The vibration element according to claim 3,
wherein the wide section is a mass adjustment section.

6. The vibration element according to claim 4,
wherein the wide section is a mass adjustment section.

7. An electronic device comprising:
the vibration element according to claim 1; and at least
a circuit section that drives the vibration element; and
a package that accommodates at least one of the vibration element and the circuit section.

8. An electronic device comprising:
the vibration element according to claim 2; and at least
a circuit section that drives the vibration element; and
a package that accommodates at least one of the vibration element and the circuit section.

9. An electronic device comprising:
the vibration element according to claim 3; and at least
a circuit section that drives the vibration element; and
a package that accommodates at least one of the vibration element and the circuit section.

10. An electronic device comprising:
the vibration element according to claim 4; and at least
a circuit section that drives the vibration element; and
a package that accommodates at least one of the vibration element and the circuit section.

11. An electronic apparatus comprising the vibration element according to claim 1.

12. An electronic apparatus comprising the vibration element according to claim 2.

13. A moving object comprising the vibration element according to claim 1.

14. A moving object comprising the vibration element according to claim 2.
